(19) United States
(12) Patent Application Publication
(10) Pub. No.: US 2007/0152974 A1
(43) Pub. Date: Jul. 5, 2007

(54) Haptic button and haptic device using the same

(75) Inventors: Kyu-yong Kim, Yongin-si (KR); Sang-youn Kim, Seoul (KR); Byung-seok Soh, Suwon-si (KR); Gyung-hye Yang, Seoul (KR); Yong-beom Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/588,219

(22) Filed: Oct. 27, 2006

(30) Foreign Application Priority Data
Jan. 3, 2006 (KR) 10-2006-0000672

(51) Int. Cl. G09G 5/00; G06F 3/02

(52) U.S. Cl. 345/168

(57) ABSTRACT

A haptic button providing various stimulations to a user according to a current application and a haptic device using the same are provided. The haptic button includes an electro-active polymer having a flat shape, a pair of electrodes contacting two sides of the electro-active polymer, an electric circuit applying a predetermined voltage to the pair of electrodes, and a sensor sensing a button input from a user, wherein stimulation provided from the electro-active polymer to the user is changed by changing a waveform of the voltage according to a current application status.

### CROSS-REFERENCE TO RELATED APPLICATIONS

This application claims the benefit of Korean Patent Application No. 10-2006-0000672 filed on Jan. 3, 2006 in the Korean Intellectual Property Office, the disclosure of which is incorporated herein by reference in its entirety.

### BACKGROUND OF THE INVENTION

1. Field of the Invention

The present invention relates to a haptic input device, and more particularly, to a haptic button providing various stimulations to a user according to a current application and a haptic device using the same.

2. Description of the Related Art

The term “haptic” generally refers to computer touch technology and is from the Greek “haptesthai” meaning relating to the sense of touch. Conventional computer technology usually uses vision or hearing information for interaction with a human being. However, with the development of technology, users have wanted more specific and realistic information through a virtual reality. To satisfy the users' want, haptic technology for transmitting the sense of touch and force has been developed.

The haptic technology is largely divided into force feedback technology and tactile feedback technology. The force feedback technology allows a user to feel a force and a motion through a mechanical interface and is wide spread in daily life. For example, when a user shoots a gun in games, actual repulsive power is transmitted to a joystick. When a car driven by a user collides with another car in games, a virtual impact is transmitted to a steering wheel.

The tactile feedback technology is mainly used in medicine. A three-dimensional image showing an anatomical structure of a virtual patient is displayed on a computer screen, thereby providing simulation allowing a surgeon to perform operations. Here, the surgeon's mechanoreceptor is stimulated through a device such as a small pin moved by compressed air or electricity so that the surgeon can feel like actually touching skin tissue.

Such haptic technology can be widely used in various fields such as game simulation and medical simulation requiring too much costs, time, or risk to directly experience.

With the development of information and telecommunication technology including Internet and computers, many digital devices satisfying the tastes and demands of customers have been manufactured and spread. Recently, digital devices such as mobile phones, personal digital assistants (PDAs), portable multimedia players (PMPs), digital cameras, portable game devices, and MP3 players characterized by convenient portability have particularly attracted customers' interest.

Such digital devices usually include a key or button input device. Conventional button input devices are simply used to input commands. FIG. 1 illustrates a conventional button input device 10.

To make a button input, a user presses a key top 11. A rubber cover 12 contacts the bottom of the key top 11. When the key top 11 is pressed, the rubber cover 12 is also pressed downward. When the rubber cover 12 eventually pushes down a metal dome 14, the user can perceive that a corresponding key is pressed through the sense of touch or hearing. Generally, force acting on the metal dome 14 and displacement generated by the transformation of the metal dome 14 are illustrated in FIG. 2. Referring to FIG. 2, a user feels a clicking feeling at an inflection point 21 where a force changes from increase to decrease.

The transformed metal dome 14 presses down a film 15 having upper contacts 17 and the upper contacts 17 become in contact with a lower contact 18. Then, a predetermined circuit connected to the upper contacts 17 and the lower contact 18 senses that the button input is made.

In such a button input procedure, repulsive power or a clicking feeling provided to a user simply depends on the material or structure of the metal dome 14. Accordingly, the same repulsive power or clicking feeling is provided regardless of a type of application unless the metal dome 14 is replaced. However, when haptic technology is applied to a button, a user pressing the button can feel different stiffness according to an application. In other words, when the haptic technology is used, a user has soft sensation when pressing a soft object and has stiff sensation when pressing a hard object.

As described above, haptic technology has been used and developed in many fields. However, a technique of adaptively providing force feedback or tactile feedback according to an application or a function of a button in a button input device wide spread as an input device has not been researched and developed satisfactorily. In particular, additional consideration is needed to use a haptic button for a variety of portable devices becoming smaller and lighter.

### SUMMARY OF THE INVENTION

Additional aspects and/or advantages of the invention will be set forth in part in the description which follows and, in part, will be apparent from the description, or may be learned by practice of the invention.

The present invention provides a haptic button for providing diverse stimulations to a user according to an application or a function of a button, thereby facilitating the operation of an object.

The present invention also provides a haptic button for informing a user whether the haptic button is available at a current time.

According to an aspect of the present invention, there is provided a haptic button including an electro-active polymer layer, a pair of electrodes which partially contact two sides of the electro-active polymer layer, a power supply to supply a voltage to the pair of electrodes, and a sensor to sense a button input from a user, wherein stimulation, provided from the electro-active polymer layer of the haptic button to the user who contacts the haptic button, is changed by changing a waveform of the voltage.

According to another aspect of the present invention, there is provided a haptic button including an electro-active polymer layer, a pair of electrodes which partially contact two sides of the electro-active polymer layer, a power supply to supply a voltage to the pair of electrodes, and a sensor to sense a button input from a user, wherein one side of the electro-active polymer layer includes a plurality of notches which open when the voltage is applied to the electrodes.

According to still another aspect of the present invention, there is provided a haptic button including an electro-active polymer layer divided into regions, a plurality of pairs of electrodes which partially contact two sides of the electro-active polymer, a power supply to supply a voltage to the plurality of pairs of electrodes, a sensor to sense a button input from a user, a fixing portion which fixes the electro-active polymer layer at an edge of the haptic button, and at least one separator which extends in at least one direction between a widthwise direction and a lengthwise direction of the haptic button, wherein each separator fixes a portion of the electro-active polymer contacting the at least one separator, wherein one of the pairs of electrodes is disposed in each of the regions into which the haptic button is divided by the at least one separator.

According to a further aspect of the present invention, there is provided a haptic device including a contact surface to physically contact a user, an actuator to provide a displacement or a force to the contact surface, a sensor to sense a button input from a user, and a controller to control an operation of the actuator by applying a voltage, wherein the actuator comprises an electro-active polymer layer and at least a pair of electrodes to which the voltage is applied and which contact the electro-active polymer layer, and stimulation provided from the electro-active polymer layer to the user is changed by changing a waveform of the voltage.

According to a further aspect of the present invention, there is provided a haptic button including an electro-active polymer layer; a pair of electrodes which partially contact two sides of the electro-active polymer layer; a power supply to supply a voltage to the pair of electrodes; a sensor to sense a button input from a user; and a fixing portion which fixes the electro-active polymer layer so that a part of the electro-active polymer layer is not expanded, wherein another part of the electro-active polymer layer expands when voltage is applied.

According to a further aspect of the present invention, there is provided a method for changing at least one of stiffness and texture in a haptic button having an electro-polymer layer which contacts at least one pair of electrodes on opposite sides of the electro-polymer layer, the method including generating a voltage having a waveform; and supplying the voltage to the at least one pair of electrodes to expand the electro-polymer layer to change at least one of stiffness and texture of the haptic button.

According to a further aspect of the present invention, there is provided at least one computer readable medium storing instructions that control at least one processor to perform a method for changing at least one of stiffness and texture in a haptic button having an electro-polymer layer which contacts at least one pair of electrodes on opposite sides of the electro-polymer layer, the method including generating a voltage having a waveform; and supplying the voltage to the at least one pair of electrodes to expand the electro-polymer layer to change at least one of stiffness and texture of the haptic button.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a conventional button input device;

FIG. 2 is a graph of force versus displacement in the conventional button input device illustrated in FIG. 1;

FIGS. 3A and 3B illustrate the characteristics of an electro-active polymer and particularly a dielectric polymer;

FIGS. 4A and 4B illustrate the basic concept of a haptic button according to a first exemplary embodiment of the present invention;

FIGS. 5A and 5B illustrate the basic concept of a haptic button according to a second exemplary embodiment of the present invention;

FIGS. 6A and 6B illustrate the basic concept of haptic buttons according to a third exemplary embodiment of the present invention;

FIG. 7 illustrates the appearance of a portable device including the haptic button according to any one among the first through third exemplary embodiments of the present invention;

FIGS. 8A through 8F are diagrams for explaining the detailed structure of the haptic button according to the first exemplary embodiment of the present invention;

FIGS. 9A and 9B are cross sectional views illustrating the detailed structure of the haptic button according to the second exemplary embodiment of the present invention;

FIGS. 10A through 10F are diagrams for explaining the detailed structures of haptic buttons according to the third exemplary embodiment of the present invention; and

FIG. 11 is a block diagram of a haptic device according to an exemplary embodiment of the present invention.

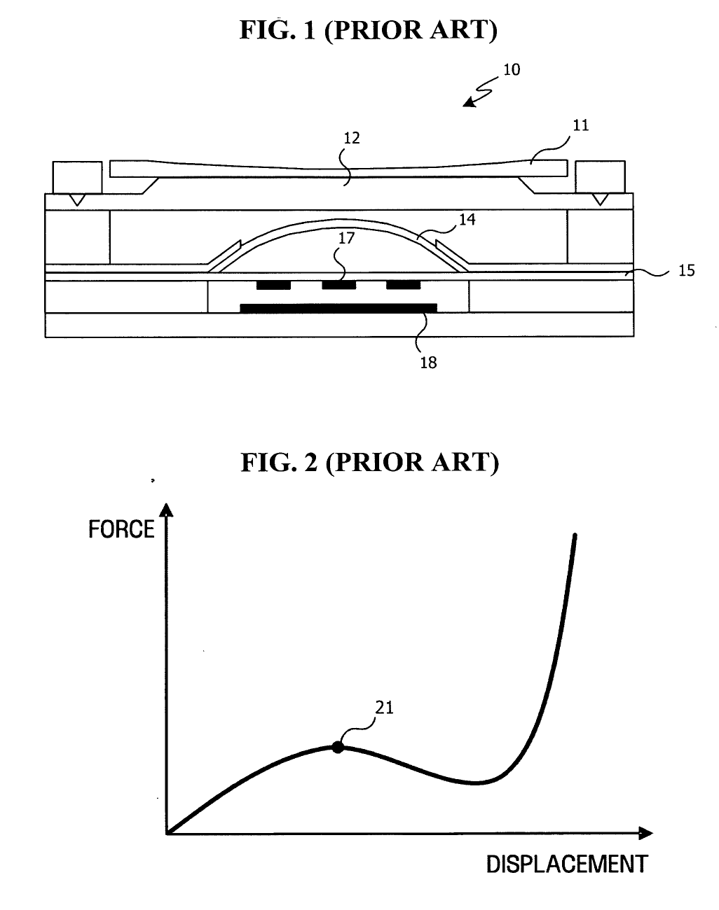

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The present invention may, however, be embodied in many different forms and should not be construed as being limited to exemplary embodiments set forth herein. Rather, these exemplary embodiments are provided so that this disclosure will be thorough and complete and will fully convey the concept of the invention to those skilled in the art.

The present invention provides a haptic button that provides diverse stimulations to a user according to an application status using an electro-active polymer having a fixing portion. The application status indicates a current status of an application that is being performed at a current time. For example, the application status includes event generation such as car collision or gunshot and an input mode such as a telephone number input mode.

Electro-active polymers (EAPs) are polymers that have a wide range of physical and electrical properties.

Upon application of an electrical current, EAPs exhibit a considerable displacement or strain, generally called deformation. Such strain may differ depending on the length, width, thickness, or radial direction of a polymer material, and it is known that the strain is in a range of 10% to 50%, which is a very characteristic feature compared to a piezoelectric element which exhibits a strain only as high as about 3%. Therefore, it is advantageous in that the EAP can be almost completely controlled by a suitable electric system.

The EAP has various advantages, such as small size, easy controllability, low power consumption, high response speed, or low potential cost. Due to such advantages, EAPs are currently being actively researched and developed in a wide variety of applications, such as artificial muscles, or the like.

Since the EAP outputs an electric signal corresponding to an external physical strain applied, if any, it can be used as sensor as well. Since materials of EAP typically generate a potential difference that can be electrically measured, the EAP can be used as a sensor of force, location, speed, accelerated speed, pressure, and so on. In addition, since the EAP has a two way memory, it can also be used as a sensor or an actuator.

Known examples of the EAP include gel, ionic polymer metal composite (IPM), electro-strictive polymer, and the like. Mechanism of most of EAP materials is based on ions moving inside and outside a polymeric network. Among the above stated EAPs, the electro-strictive polymer is known as the most practical polymer from the commercial point of view.

The electro-strictive polymer can be divided into two types: a dielectric type; and a shape-transition type. The dielectric type polymer is generally disposed such that a conductive electrode and a compliant electrode are sandwiched with the dielectric type polymer interposed therebetween. Under a high electric field, e.g., several hundreds to several thousands of volts, an attractive force associated with the electrodes presses dielectric materials, resulting in a large amount of deformation, i.e., approximately 50%.

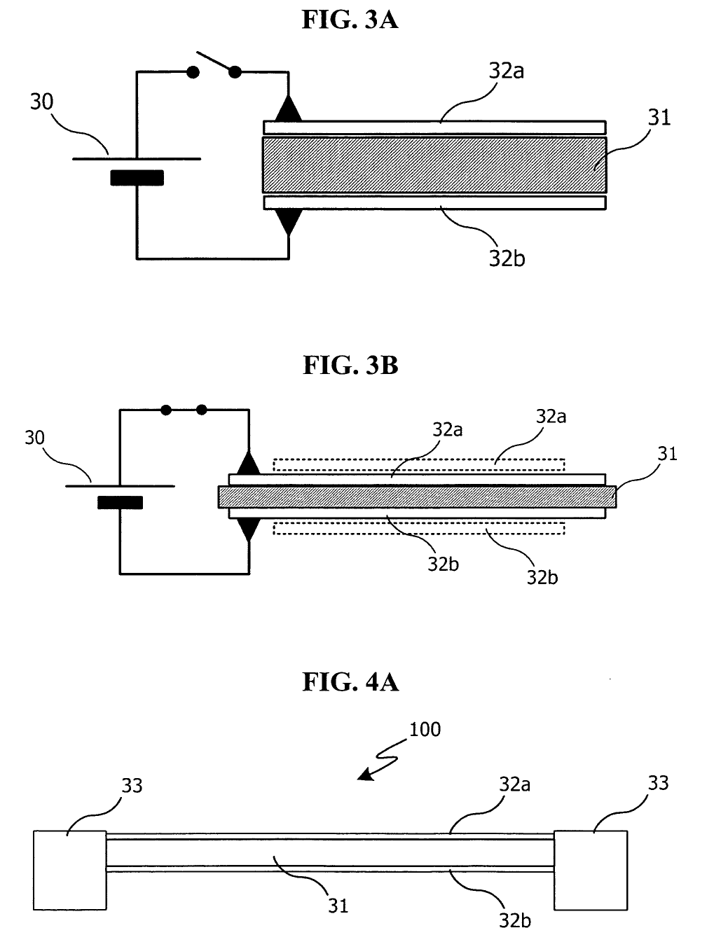

FIGS. 3A and 3B illustrate the characteristics of an electro-active polymer (EAP) and particularly a dielectric polymer. In the description hereinbelow, a dielectric polymer is used as the electro-active polymer, but the present invention is not restricted thereto.

Referring to FIG. 3A, two electrodes 32a and 32b respectively contact two sides of an electro-active polymer 31 having a predetermined thickness. Each of the two electrodes 32a and 32b is made of a thin film of a conductive polymer and has flexibility so that it is transformed following the transformation of the electro-active polymer 31.

When the power of a power supply 30 is not supplied to the electrodes 32a and 32b, the electro-active polymer 31 is in an initial state as illustrated in FIG. 3A. When the power of the power supply 30 is supplied to the electrodes 32a and 32b, the electro-active polymer 31 is transformed such that it becomes thinner and expands as illustrated in FIG. 3B. Here, the electrodes 32a and 32b having flexibility are transformed following the transformation of the electro-active polymer 31.

The present invention provides a haptic button having various functions using an electro-active polymer. In detail, a haptic button according to a first exemplary embodiment of the present invention provides a variable sense of touch to a user. Here, a plurality of haptic buttons having different stiffnesses may provide different operation feelings to a user or a single haptic button may have different stiffnesses according to circumstances. For example, stiffness of a Run button used in a car racing game may be increased when a user drives a car up a hill and decreased when the user drives the car down the hill so that the user can have the sense of touch similar to a real sensation.

A haptic button according to a second exemplary embodiment of the present invention provides different textures according to circumstances. Here, both of the stiffness and the texture of the haptic button may be changed.

A haptic button according to a third exemplary embodiment of the present invention allows a user to identify a button that the user touches at a current time without visually identifying it.

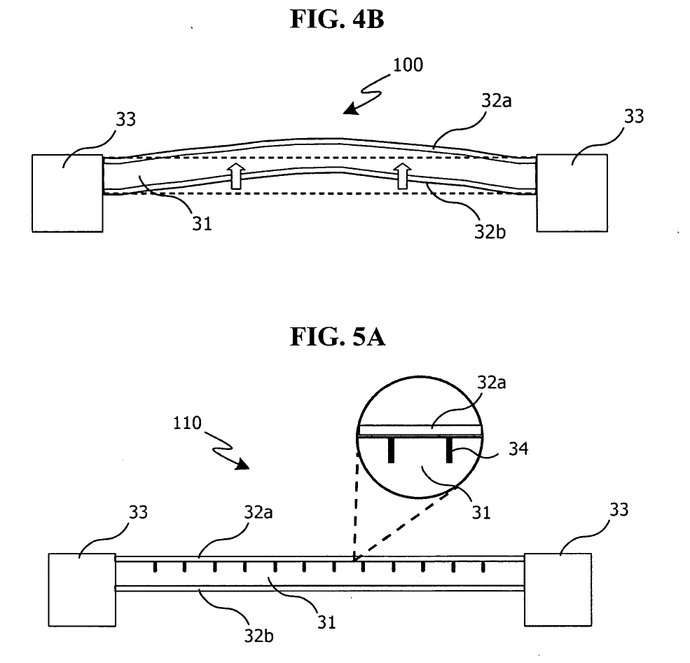

The basic concepts of the above-described three types of haptic buttons according to exemplary embodiments of the present invention will be described with reference to FIGS. 4A through 6B.

FIGS. 4A and 4B illustrate the basic concept of a haptic button according to a first exemplary embodiment of the present invention, in which FIG. 4A illustrates a state of a haptic button 100 according to the first embodiment of the present invention before application of a voltage and FIG. 4B illustrates a state of the haptic button 100 after the application of the voltage.

Referring to FIG. 4A, two sides of the electro-active polymer 31 contact the two electrodes 32a and 32b, respectively. In other words, the two electrodes 32a and 32b and the electro-active polymer 31 form a sandwich structure. Two ends of the electro-active polymer 31 are fixed to a fixing portion 33 not to have displacement.

In this situation, when a voltage is applied to the two electrodes 32a and 32b, the electro-active polymer 31 is transformed as illustrated in FIG. 4B. When the voltage is applied to the two electrodes 32a and 32b, the electro-active polymer 31 is expanded in a widthwise direction. Here, since the both ends of the electro-active polymer 31 are fixed to the fixing portion 33 and restricted in motion, the electro-active polymer 31 naturally protrudes upward or downward. If another element exists below the electro-active polymer 31 and restricts the downward protrusion of the electro-active polymer 31, the electro-active polymer 31 will protrude upward.

In a case where the electro-active polymer 31 is designed to protrude upward, when a user presses the haptic button 100, stiffness of the haptic button 100 may be controlled according to a voltage application state.

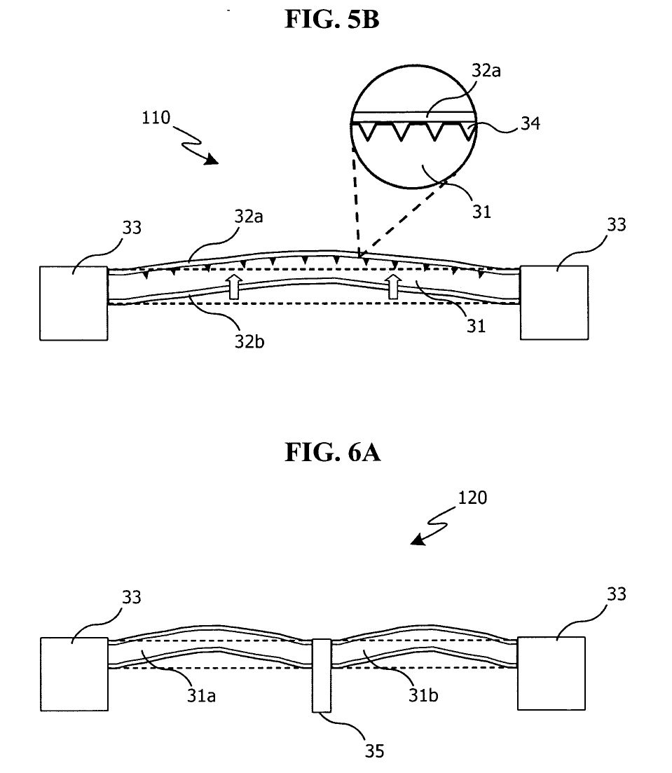

FIGS. 5A and 5B illustrate the basic concept of a haptic button according to a second exemplary embodiment of the present invention, in which FIG. 5A illustrates a state of a haptic button 110 according to the first exemplary embodiment of the present invention before application of a voltage and FIG. 5B illustrates a state of the haptic button 110 after the application of the voltage.

Referring to FIG. 5A, the electro-active polymer 31 includes a plurality of notches 34 in a side contacting the upper electrode 32a. While a voltage is not applied to the two electrodes 32a and 32b, the notches 34 are closed. Accordingly, a user does not feel a special texture even though contacting the haptic button 110.

However, when a voltage is applied to the two electrodes 32a and 32b, the electro-active polymer 31 protrudes upward and thus the notches 34 open, as illustrated in FIG. 5B. At this time, if the user contacts the haptic button 110, he/she will feel a rough texture. Even though the user does not directly contact the notches 34, the user can feel the rough texture indirectly if the upper electrode 32a disposed above the notches 34 and a film (not shown) disposed on the upper electrode 32 to directly contact the user are made using a flexible material.

A crack in each of the notches 34 becomes larger, increasing a rough texture, as the protrusion of the electro-active polymer 31 increases, that is, as the voltage applied to the two electrodes 32a and 32b increases. Accordingly, the texture of the haptic button 110 can be controlled by controlling the voltage applied to the two electrodes 32a and 32b.

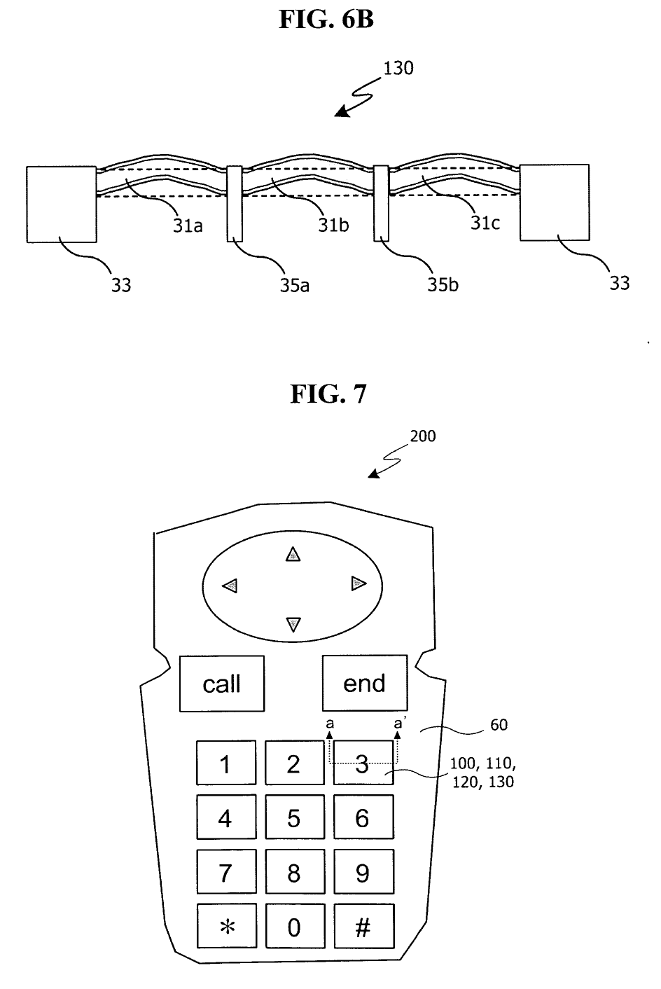

FIGS. 6A and 6B illustrate the basic concept of haptic buttons according to a third exemplary embodiment of the present invention, in which FIG. 6A illustrates a haptic button 120 further including a single separator 35 as compared to the haptic button 100 and FIG. 6B illustrates a haptic button 130 further including two separators 35a and 35b. The separators 35, 35a, and 35b suppress the horizontal expansion of an electro-active polymer but allow the electro-active polymer to move up and down according to a pressure applied by a user.

Two electro-active polymers 31a and 31b separated by the separator 35 illustrated in FIG. 6A and three electro-active polymers 31a, 31b, and 31c separated by the separators 35a and 35b illustrated in FIG. 6B may be separately controlled using electrodes separately driving the electro-active polymers 31a, 31b, and 31c. Accordingly, the electro-active polymers 31a, 31b, and 31c may have different heights of protrusion and only some of the electro-active polymers 31a, 31b, and 31c may be activated.

FIG. 7 illustrates the appearance of a portable device 200 including the haptic button 100, 110, 120, or 130. All of buttons included in the portable device 200 or only some of them may be the haptic button 100, 110, 120, or 130. The buttons included in the portable device 200 are defined by a face plate 60.

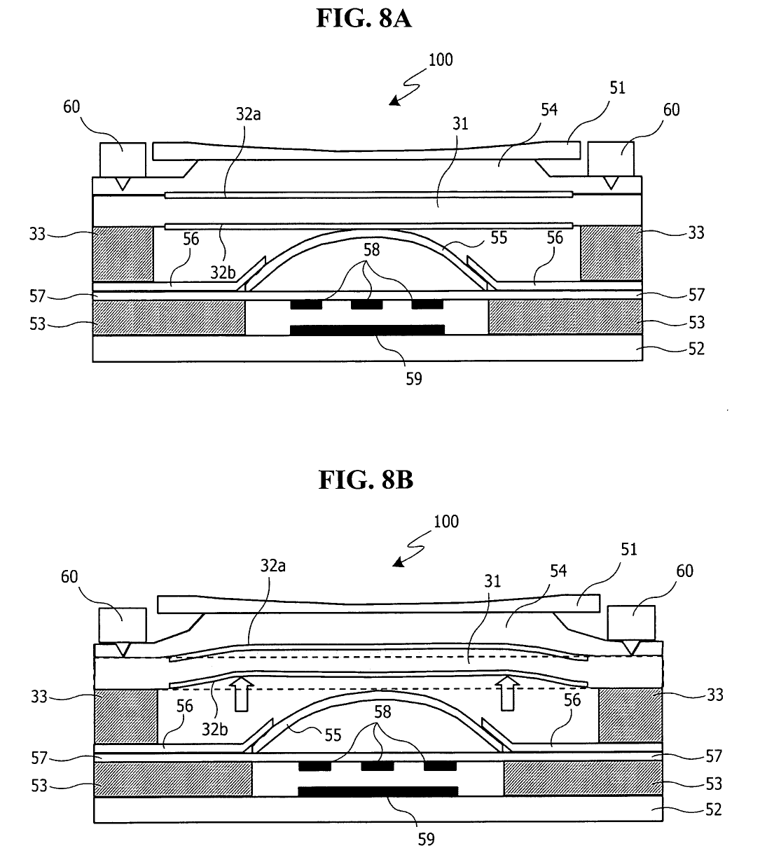

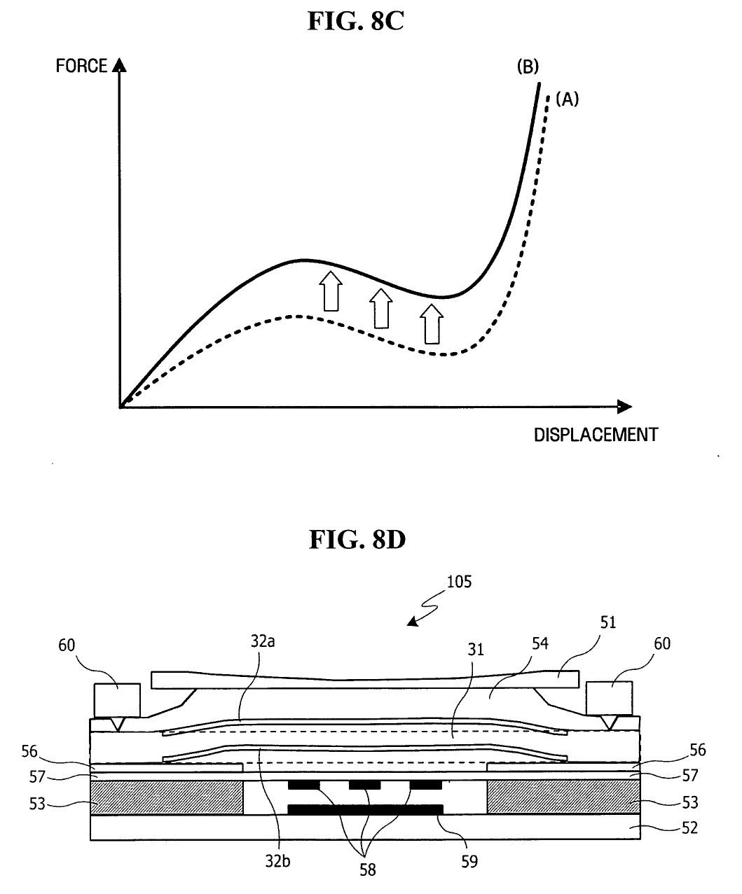

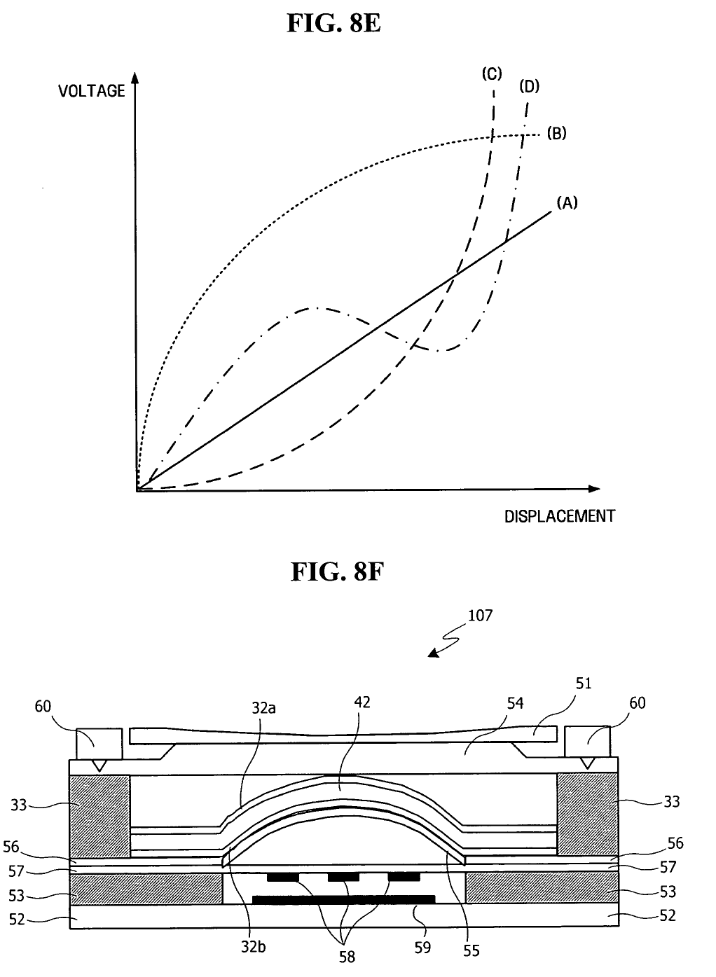

FIGS. 8A, 8B, 8D, and 8F are cross sectional views of the haptic buttons 100, 110, 120, or 130 illustrated in FIG. 7, taken along the line a-a′. FIGS. 8A through 8C are diagrams for explaining the detailed structure of the haptic button 100 according to the first exemplary embodiment of the present invention.

Referring to FIG. 8A, the haptic button 100 may include a key top 51 physically contacting a user, a rubber cover 54 disposed blow the key top 51, the electro-active polymer 31 disposed below the rubber cover 54, the two electrodes 32a and 32b respectively disposed at both sides of the electro-active polymer 31, a metal dome 55 disposed below the electro-active polymer 31 to provide a clicking feeling when the user presses the haptic button 100, and upper contacts 58 and a lower contact 59, which are disposed below the metal dome 55 and contact each other when the haptic button 100 is pressed.

In addition, a position of the metal dome 55 is fixed by a plate 56. The fixing portion 33 is disposed between the electro-active polymer 31 and the plate 56 to secure a space for the metal dome 55. As described above, the fixing portion 33 also fixes the electro-active polymer 31 so that the horizontal motion of the electro-active polymer 31 is suppressed. In addition, a spacer 53 is disposed between a flexible film 57, to which the upper contacts 58 are attached, and a lower case 52, to which the lower contact 59 is attached, to separate the upper contacts 58 from the lower contact 59. The haptic button 100 is defined by the face plate 60.

The electro-active polymer 31 may be spread throughout an area including a plurality of haptic buttons 100, but the two electrodes 32a and 32b are provided for each of the haptic buttons 100. Accordingly, when a voltage is applied to the two electrodes 32a and 32b included in a particular haptic button 100, only the particular haptic button can be activated.

FIG. 8B illustrates a state of the haptic button 100 illustrated in FIG. 8A when a voltage is applied to the two electrodes 32a and 32b. When a voltage is applied to the two electrodes 32a and 32b, the electro-active polymer 31 is expanded and protrudes upward and provides repulsive power to a user pressing the haptic button 100 according to a level of the voltage. The metal dome 55 illustrated in FIGS. 8A and 8B has a predetermined stiffness. An artificial stiffness of the electro-active polymer 31 is added to the predetermined stiffness of the metal dome 55 so that overall stiffness appropriate to a current status can be provided to the user.

FIG. 8C is a graph of displacement generated when a user presses the haptic button 100 versus force (or pressure) provided to the user. A curve (A) is a force-displacement graph of the metal dome 55 and a curve (B) is a force-displacement graph obtained when the electro-active polymer 31 is activated. When the stiffness of the metal dome 55 is referred to as a bias stiffness, overall stiffness can be variously changed by adjusting a stiffness added by the electro-active polymer 31.

Referring to FIGS. 8A and 8B, the metal dome 55 is used to provide the bias stiffness. However, various levels of stiffness can be provided to a user by using only the electro-active polymer 31 without using the metal dome 55. FIG. 8D illustrates a haptic button 105 providing stiffness using only the electro-active polymer 31.

In the haptic button 105, the plate 56 and the flexible film 57 are disposed below the electro-active polymer 31. When a voltage is applied to the two electrodes 32a and 32b, the electro-active polymer 31 protrudes upward. Here, if the voltage is applied in various waveforms, the haptic button 105 can provide a user with various stimulations such as vibration and impact. In addition, the strength of stimulation can be controlled by controlling a level of the voltage.

FIG. 8E illustrates various stimulations that can be provided by the haptic button 105. The strength of stimulation can be controlled by a voltage applied to the two electrodes 32a and 32b. The voltage changes according to displacement generated when a user presses the haptic button 105 or a period of time during which the user presses down the haptic button 105.

In FIG. 8E, a curve (A) shows a voltage waveform for providing stimulation linearly increasing according to displacement, a curve (B) shows a voltage waveform for providing impact stimulation, a curve (C) shows a voltage waveform for providing stimulation rapidly increasing according to the displacement, and a curve (D) shows a voltage waveform for providing stimulation similar to that provided by the metal dome 55. Besides, many other stimulations can be provided to a user by changing the waveform of the applied voltage.

Meanwhile, FIG. 8A illustrates that the lower electrode 32b partially contacts the metal dome 55, and at least part of the electro-active polymer 31 forms a horizontal layer on the lower electrode 32b. However, a structure in which the lower electrode 32b contacts an upper curve of the metal dome 55 may be considered, and at least part of the electro-active polymer 31 contacts the lower electrode 32b at the upper curve of the metal dome 55. FIG. 8F illustrates a haptic button 107 minimizing a distance between an electro-active polymer 42 and the metal dome 55, as a modification of the haptic button 100 illustrated in FIG. 8A. When the distance between the electro-active polymer 42 and the metal dome 55 is minimized, stimulation can be continuously provided to a user by the electro-active polymer 42 and the metal dome 55. Here, the fixing portion 33 also suppresses the horizontal motion of the electro-active polymer 42.

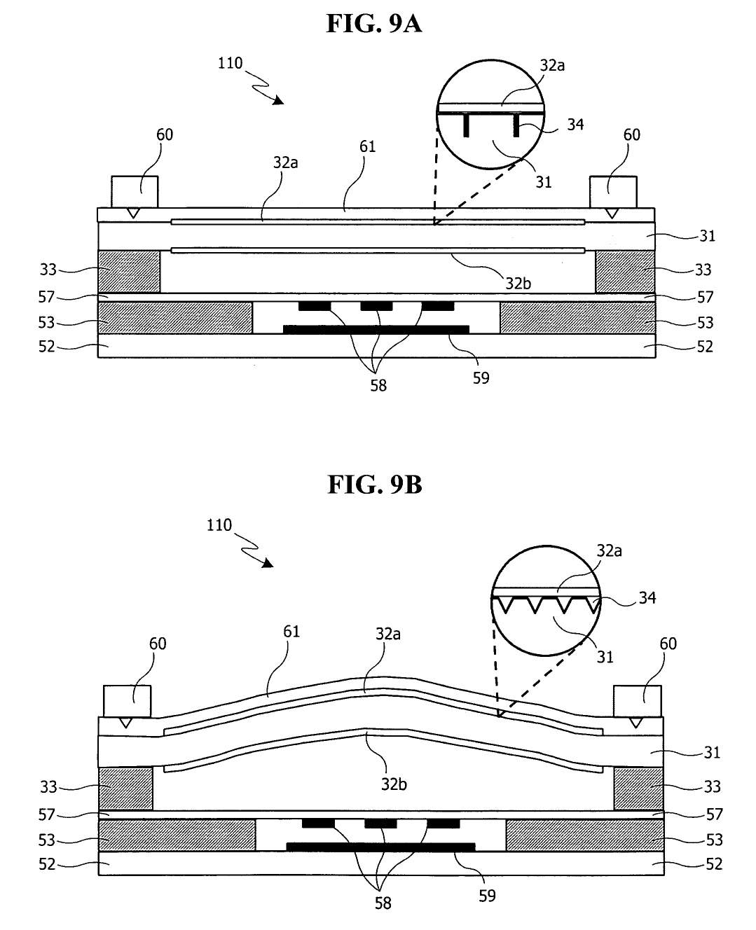

FIGS. 9A and 9B are cross sectional views illustrating the detailed structure of the haptic button 110 according to the second exemplary embodiment of the present invention. In the second exemplary embodiment of the present invention, a plurality of the notches 34 are formed in the upper side of the electro-active polymer 31, i.e., the side contacting the upper electrode 32a. The fixing portion 33 is disposed between the electro-active polymer 31 and the contacts 58 and 59 to maintain a predetermined distance therebetween and suppress the horizontal motion of the electro-active polymer 31.

When a voltage is applied to the two electrodes 32a and 32b, the electro-active polymer 31 protrudes upward. Here, the notches 34 open, thereby providing a rough texture to a user contacting a contact surface 61. The roughness of texture increases when the amount of a crack in each notch 34 increases, that is, when the height of protrusion of the electro-active polymer 31 increases. Accordingly, the texture of the haptic button 110 can be controlled by controlling the voltage applied to the two electrodes 32a and 32b.

The haptic button 110 illustrated in FIGS. 9A and 9B may further include a metal dome in space maintained by the fixing portion 33.

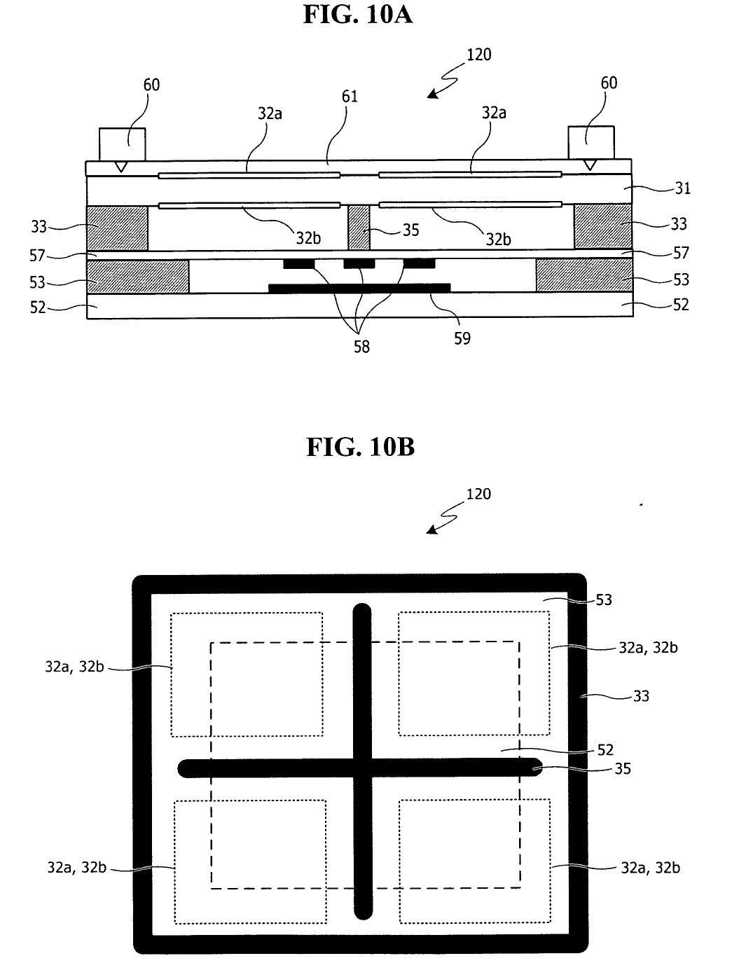

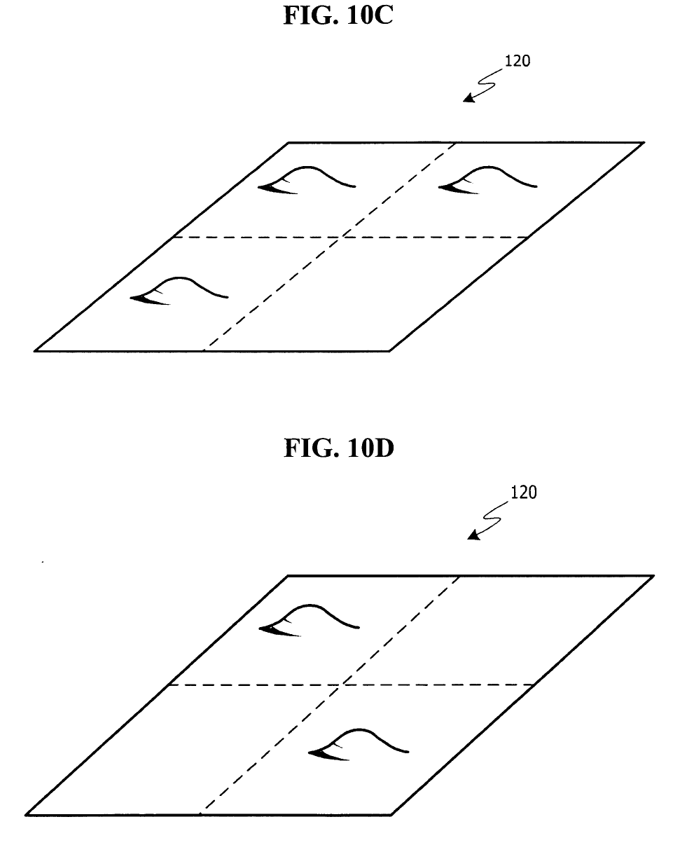

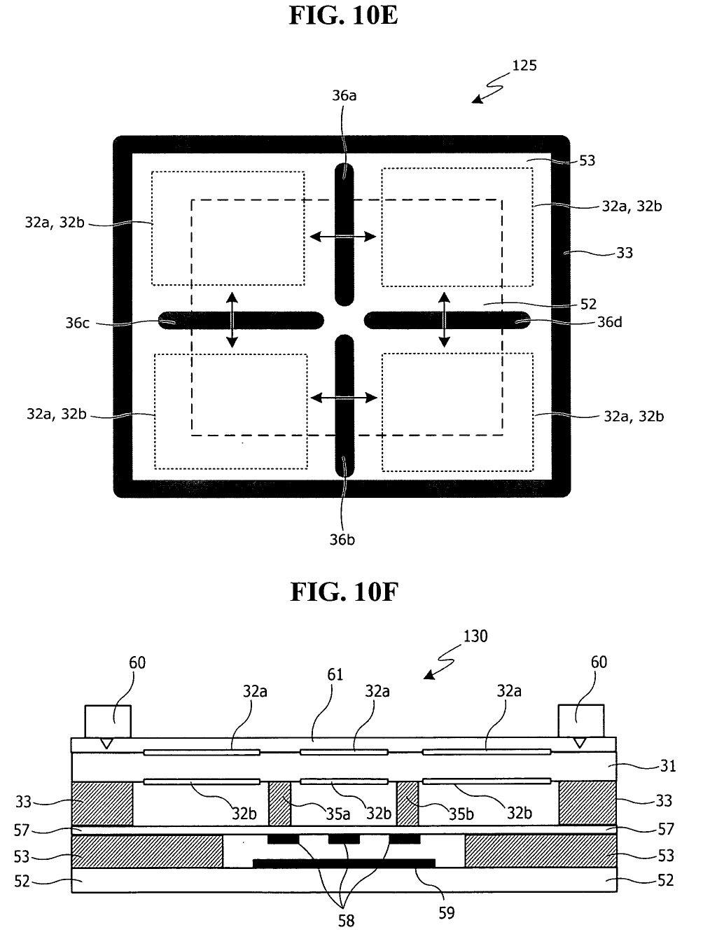

FIGS. 10A through 10F are diagrams for explaining the detailed structures of haptic buttons 120, 125, and 130 according to the third exemplary embodiment of the present invention. FIG. 10A illustrates the detailed structure of the haptic button 120 including the single separator 35. The separator 35 fixes a portion of the electro-active polymer 31 so that the portion contacting the separator 35 does hot have displacement in the horizontal direction, like the fixing portion 33, and also divides the haptic button 120 into a plurality of regions. A pair of the two electrodes 32a and 32b are disposed per region in the haptic button 120. Accordingly, the height of protrusion of the electro-active polymer 31 can be separately controlled in each of the regions by controlling a voltage applied to the pair of the two electrodes 32a and 32b in each region.

FIG. 10B is a top view of the haptic button 120. The fixing portion 33 is formed along the edge of the haptic button 120 to fix the electro-active polymer 31. The separator 35 is formed extending in the widthwise and lengthwise directions from a center of the haptic button 120. The top side of the fixing portion 33 may contact and fix the electro-active polymer 31 and the bottom side thereof may be fixed to the spacer 53.

A pair of the electrodes 32a and 32b is disposed in each of four regions defined by the separator 35. When the height of protrusion is separately controlled in the four regions by controlling a voltage applied to each pair of the electrodes 32a and 32b, the transformed shape of the haptic button 120 can be controlled, as illustrated in FIGS. 10C and 10D. In addition, stiffness of the haptic button 120 in the four regions can be separately controlled. FIG. 10C shows a transformed state of the haptic button 120 in which two upper regions and a lower left region are activated. FIG.10D shows a transformed state of the haptic button 120 in which an upper left region and a lower right region are activated.

When the haptic button 120 is used as a telephone number input button illustrated in FIG. 7, if input buttons are controlled such that different regions are protruded, a user can identify a button just by touching the button. For example, when there are four regions that can be independently protruded or not in the haptic button 120, a total of 16 cases are made. Accordingly, 12 number input buttons illustrated in FIG. 7 can be identified through the sense of touch.

When a user identifies a wanted haptic button 120 through the sense of touch and presses the haptic button 120, the upper contacts 58 become in contact with the lower contact 59 and a button input is sensed. Actually, when the haptic button 120 is not much larger than the user's finger as in a mobile telephone or when a stroke of the haptic button 120 is very small, even if the user presses the center of the haptic button 120, at least a part of the four regions is pressed, and therefore, there is no problem in button input.

The haptic button 120 may be used to provide the sense of touch to a user in an application such as a video game. When the four regions of the haptic button 120 have the same frequency, the user will feel a single stimulation. However, when at least one of the four regions has a different frequency than the other regions, the user will feel a plurality of stimulations from the single haptic button 120. Such various oscillations can be generated by controlling the waveform of a voltage applied to a pair of the electrodes 32a and 32b.

The haptic button 120 illustrated in FIGS. 10A and 10B is divided into the four regions in uniform size and shape. Unlikely, if the haptic button 125 includes a plurality of separators 36a, 36b, 36c, and 36d capable of moving in the widthwise or lengthwise direction, as is illustrated in FIG. 10E, the size of each region can be increased or decreased. In a state where a certain stimulation is provided to a user through four regions, if the size of the regions is changed, the user will feel a different stimulation from one moment.

FIG. 10F illustrates the haptic button 130 including two separators 35a and 35b. The haptic button 130 just includes one more separator than the haptic button 120 illustrated in FIGS. 10A and 10B. Accordingly, the haptic button 130 is divided into nine regions. In the present invention, the number of separators can be arbitrarily selected during manufacturing. In addition, the number of separators extending in the widthwise direction may be different from the number of separators extending in the lengthwise direction in a single haptic button.

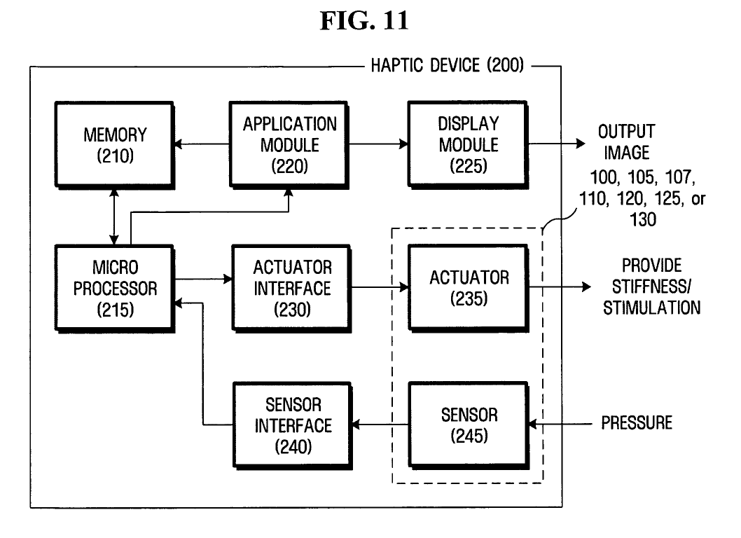

FIG. 11 is a block diagram of a haptic device 200 according to an exemplary embodiment of the present invention. The haptic device 200 includes a micro processor 215, a memory 210, an application module 220, a display module 225, an actuator interface 230, an actuator 235, a sensor interface 240, and a sensor 245.

The micro processor 215 may include a universal central processing unit (CPU) or a micro computer for a specified function and controls the operations of other elements included in the haptic device 200.

To execute the application corresponding to the flag transmitted by the application selector 205, the microprocessor 215 loads the application module 220 to a predetermined region in the memory 210 and executes the loaded application module 220.

In addition, the microprocessor 215 determines an input mode mapped to the application to be executed. For example, the input mode may be a telephone number key mode, a touch pad mode, a four-direction key mode, or a multimedia key mode.

A mapping relationship between the application and the input mode may be stored in the memory 210 in the form of a predetermined mapping table. The mapping relation may not be a one-to-one correspondence and may be a many-to-one correspondence. In other words, the same input mode may be used in different applications.

The memory 210 is loaded with the application module 220 at the predetermined region in processor or thread units. In addition, the memory 210 may store the mapping table. In general, the memory 210 may be implemented by a nonvolatile memory such as ROM (read only memory), PROM (programmable ROM), EPROM (electrically programmable ROM), EEPROM (electrically erasable programmable ROM) or a flash memory, a volatile memory such as RAM, a storage medium such as a hard disk, or other different types of memories known in the art.

The application module 220 is loaded to the memory 210 by the microprocessor 215 and then executed. The application module 220 provides an execution procedure or an execution result to the display module 225.

The display module 225 outputs the execution procedure or the execution result of the application module 220 so that a user can visually and/or auditorily perceive it. The display module 225 fundamentally includes a liquid crystal display (LCD), a cathode-ray tube (CRT), a plasma display panel (PDP), a light emitting diode (LED), an organic LED (OLED), a three-dimensional goggle, or other image output device and may further include an amplifier and a speaker for audio output.

The haptic button 100, 105, 107, 110, 120, 125, or 130 according to an exemplary embodiment of the present invention includes at least the actuator 235 and the sensor 245 and may further include the actuator interface 230 and the sensor interface 240.

The actuator 235 generates and outputs a force or displacement in response to a signal that is generated by the micro processor 215 and then converted by the actuator interface 230. In the current exemplary embodiment of the present invention, the actuator 235 includes the electro-active polymer 31 or 42; the electrodes 32a and 32b for activating the electro-active polymer 31 or 42; and a power supply (not shown). The actuator may also include electro-active polymers 31a, 31b, and the like.

The micro processor 215 provides an input voltage having an appropriate waveform stored in the memory 210 to the actuator 235 according to a current application. The input voltage includes a direct current voltage, an alternating current voltage having a sine wave, a triangle wave, or a square wave, and voltages having various waveforms as illustrated in FIG. 8E.

The actuator 235 activates the electrodes 32a and 32b with the input voltage transmitted from the micro processor 215 via the actuator interface 230. In addition, the actuator 235 may further include the metal dome 55 when it is needed to add an additional clicking feeling (or a bias stiffness), as illustrated in FIGS. 8A and 8F.

The actuator interface 230 is connected between the actuator 235 and the micro processor 215 and converts a signal generated from the micro processor 215 into a signal appropriate for driving of the actuator 235. As is well known to those skilled in the art, the actuator interface 230 may include a power amplifier, a switch, a digital-to-analog converter (DAC), an analog-to-digital converter (ADC), and other elements.

When a button input from a user is sensed, the sensor 245 generates a signal corresponding to the button input and transmits the signal to the micro processor 215 via the sensor interface 240. The sensor 245 may be implemented by a contact switch or a touch pad, which is usually used in a button input device, or may be implemented by the electro-active polymer 31 or 42. The electro-active polymer 31 or 42 is interactive like it is changed by a voltage and reversely generates a voltage when it is transformed by an external force. Accordingly, the electro-active polymer 31 or 42 may be used as the actuator 235 and the sensor 245.

The sensor interface 240 is connected between the micro processor 215 and the sensor 245 and converts a signal output from the sensor 245 into a signal that can be analyzed by the micro processor 215.

The haptic device 200 illustrated in FIG. 11 can be used for portable devices such as a mobile phone, a personal digital assistant (PDA), a portable multimedia player (PMP), a digital camera, a portable game device, and a MP3 player and other various devices such as a desktop computer, a laptop computer, a digital television, and home appliance.

The respective components shown in FIG. 11 may be implemented by software components or modules executed in a predetermined area on a memory, such as task, class, subroutine, process, object, execution thread, or program components, or hardware components, such as FPGA (field-programmable gate array) or ASIC (application-specific integrated circuit). The functionality provided for in the components and modules may be combined into fewer components and modules or further separated into additional components and modules. In addition, the components and modules may be implemented such that they execute one or more computers. A software module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and the modules can operate at least one processor (e.g. central processing unit (CPU) such as a microprocessor). For example, a software module may advantageously be configured to reside on an addressable storage medium and configured to execute on one or more processors.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, or DVDs), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission media. For example, storage/transmission media may include optical wires/lines, waveguides, and metallic wires/lines, etc. including a carrier wave transmitting signals specifying instructions, data structures, data files, etc. The medium/media may also be a distributed network, so that the computer readable code/instructions are stored/transferred and executed in a distributed fashion. The medium/media may also be the Internet. The computer readable code/instructions may be executed by one or more processors. The computer readable code/instructions may also be executed and/or embodied in at least one application specific integrated circuit (ASIC) or as FPGA (field-programmable gate array).

According to the present invention, a haptic button provides various stimulations to a user according to a current application or a button function, thereby facilitating the operation of an object.

Accordingly, when the user interacts with an object such as a menu or an icon displayed on a display unit, attributes corresponding to the object can be given to the haptic button so that the haptic button provides the user with the tactile sensation, texture, and stiffness of the object displayed on the display unit.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A haptic button comprising:
an electro-active polymer layer;
a pair of electrodes which partially contact two sides of the electro-active polymer layer;
a power supply to supply a voltage to the pair of electrodes; and
a sensor to sense a button input from a user,
wherein stimulation, provided from the electro-active polymer layer of the haptic button to the user who contacts the haptic button, is changed by changing a waveform of the voltage.

2. The haptic button of claim 1, further comprising a fixing portion which fixes the electro-active polymer layer so that a part of the electro-active polymer layer is not expanded.

3. The haptic button of claim 1, wherein the change in the stimulation is change in stiffness of the haptic button.

4. The haptic button of claim 1, further comprising a metal dome providing a bias stiffness to the user, wherein one of the electrodes at least partially contacts an upper curve of the metal dome.

5. The haptic button of claim 1, wherein the waveform of the voltage is changed according to a current application status.

6. The haptic button of claim 1, wherein the sensor includes a contact switch or a touch pad.

7. A haptic button comprising:
an electro-active polymer layer;
a pair of electrodes which partially contact two sides of the electro-active polymer layer;
a power supply to supply a voltage to the pair of electrodes; and
a sensor to sense a button input from a user,
wherein one side of the electro-active polymer layer comprises a plurality of notches which open when the voltage is applied to the electrodes.

8. The haptic button of claim 7, wherein the user senses a rough texture when the notches are open and wherein the amount of opening in each of the notches increases in proportion to a level of the voltage supplied by the power supply to the pair of electrodes and the rough texture increases as the amount of the opening increases.

9. The haptic button of claim 7, wherein a unique rough texture is given to the haptic button by applying voltage to the electrodes to allow the user to identify the haptic button just through the sense of touch.

10. The haptic button of claim 7, further comprising a fixing portion which fixes the electro-active polymer layer so that a part of the electro-active polymer layer is not expanded.

11. The haptic button of claim 7, wherein the sensor includes a contact switch or a touch pad.

12. A haptic button comprising:
an electro-active polymer layer divided into regions;
a plurality of pairs of electrodes which partially contact two sides of the electro-active polymer layer;
a power supply to supply voltage to the plurality of pairs of electrodes;
a sensor to sense a button input from a user;
a fixing portion which fixes the electro-active polymer layer at an edge of the haptic button; and
at least one separator which extends in at least one direction between a widthwise direction and a lengthwise direction of the haptic button, wherein each separator fixes a portion of the electro-active polymer layer contacting the separator,
wherein one of the pairs of electrodes is disposed in each of the regions into which the haptic button is divided by the at least one separator.

13. The haptic button of claim 12, wherein the sensor includes a contact switch or a touch pad.

14. The haptic button of claim 12, wherein voltage is applied to each pair of electrodes in each region in a unique manner to change texture of the haptic button.

15. The haptic button of claim 12, wherein voltage is applied to at least some of pairs of electrodes included in the regions in a unique manner to change texture of the haptic button.

16. The haptic button of claim 12, wherein the separator is moved in the widthwise direction, thereby changing a shape of each region and changing a stimulation provided from the electro-active polymer layer to the user.

17. A haptic device comprising:
a contact surface to physically contact a user;
an actuator to provide a displacement or a force to the contact surface;
a sensor to sense a button input from a user; and
t a controller to control an operation of the actuator by applying a voltage,
wherein the actuator comprises an electro-active polymer layer and at least a pair of electrodes to which the voltage is applied and which contact the electro-active polymer layer, and
wherein stimulation provided from the electro-active polymer layer of the haptic button to the user is changed by changing a waveform of the voltage.

18. The haptic device of claim 17, wherein the actuator further comprises a fixing portion which fixes the electro-active polymer layer so that a part of the electro-active polymer layer is not expanded.

19. The haptic device of claim 17, wherein the change in the stimulation is change in stiffness of the haptic button.

20. The haptic device of 17, wherein the actuator further comprises a metal dome providing a bias stiffness to the user, wherein one of the at least one pair of electrodes at least partially contacts an upper curve of the metal dome.

21. The haptic device of claim 17, wherein the waveform of the voltage is changed according to a current application status.

22. The haptic device of claim 17, wherein the sensor includes a contact switch or a touch pad.

23. The haptic button of claim 12, wherein voltage is applied to one of pairs of electrodes in one of the regions in a unique manner to change texture of the haptic button.

24. A haptic button comprising:
an electro-active polymer layer;
a pair of electrodes which partially contact two sides of the electro-active polymer layer;
a power supply to supply a voltage to the pair of electrodes;
a sensor to sense a button input from a user; and
a fixing portion which fixes the electro-active polymer layer so that a part of the electro-active polymer layer is not expanded,
wherein another part of the electro-active polymer layer expands when voltage is applied.

25. The haptic button of claim 24, wherein the expansion of the another part of the electro-active polymer layer increases the stiffness of the haptic button.

26. The haptic button of claim 25, wherein the stiffness of the haptic button increases as the level of voltage applied to the electro-active polymer layer increases.

27. The haptic button of claim 25, wherein the stiffness of the haptic button decreases as the level of voltage applied to the electro-active polymer layer decreases.

28. The haptic button of claim 24, wherein the voltage has a waveform and the stiffness of the haptic button is changed by changing the waveform of the voltage.

29. The haptic button of claim 24, the waveform of the voltage is changed according to a current application status.

30. A method for changing at least one of stiffness and texture in a haptic button having an electro-polymer layer which contacts at least one pair of electrodes on opposite sides of the electro-polymer layer, the method comprising:
generating a voltage having a waveform; and
supplying the voltage to the at least one pair of electrodes to expand the electro-polymer layer to change at least one of stiffness and texture of the haptic button.

31. At least one computer readable medium storing instructions that control at least one processor to perform a method for changing at least one of stiffness and texture in a haptic button having an electro-polymer layer which contacts at least one pair of electrodes on opposite sides of the electro-polymer layer, the method comprising”
generating a voltage having a waveform; and
supplying the voltage to the at least one pair of electrodes to expand the electro-polymer layer to change at least one of stiffness and texture of the haptic button.
